(19) United States
(12) Patent Application Publication
(10) Pub. No.: US 2022/0122187 A1
(43) Pub. Date: Apr. 21, 2022

(54) METHOD OF SECURED PROCEDURAL APPLICATION FOR REVENUE GENERATION AND REVENUE MANAGEMENT

(71) Applicant: John Dillon, Franklin, TN (US)

(72) Inventor: John Dillon, Franklin, TN (US)

(21) Appl. No.: 17/071,841

(22) Filed: Oct. 15, 2020

(51) Int. Cl. G06Q 40/00; G06Q 40/02; G06Q 20/12; G06Q 50/00; G06Q 50/26; G06Q 10/10; G06Q 10/02

(52) U.S. Cl. CPC G06Q 40/123; G06Q 40/02; G06Q 20/127; G06F 21/31; G06Q 50/26; G06Q 10/1093; G06Q 10/02; G06Q 50/01

(57) ABSTRACT

The present invention relates to method of secured procedural application which creates opportunities for generation of revenue followed by automated financial management of same on a single platform. Automated revenue management comprises but not limited to revenue generation, displaying generated revenues received, with holding a percent of revenue as service fee and providing automated tax filing service on behalf of subscriber. Method of process application consists of three interdependent modules which include: 1. User application 2. Subscriber application and 3. Web-based application. The secured procedural application comprises of first module, which is a platform for registration through payment for users and subscribers and also creates payment based communication between Users and Subscribers. Second module is Subscriber usage only module showcasing usage of specific options and third module is for Subscriber administrative use and automated revenue management.

### BRIEF DESCRIPTION OF DRAWINGS

The detailed description is set forth to with reference to accompanying figures. In figures the left most digits of reference numbers identify the figures in which reference number first appears. The use of same reference number in the different figures indicates similar or identical items or features.

FIG. 1 illustrates secured procedural application for revenue generation and tax maintenance where three interdependent modules are displayed along with their important functions.

FIG. 2 illustrates secured procedural applications displaying the interdependency of three modules

FIG. 3 illustrates detailed structure of User application along with its functions

FIG. 4 illustrates detailed structure of Subscriber application along with its functions

FIG. 5 illustrates detailed structure of Web-based application along with its functions

### BACKGROUND OF THE INVENTION

### Method of Secured Procedural Application for Revenue Generation and Revenue Management

Present invention relates to method of secured procedural application which creates opportunities for generation of revenue followed by automated financial management of same on single platform. Automated revenue management comprises but not limited to revenue generation, displaying generated revenues received, with holding a percent of revenue as service fee and providing automated tax filing service on behalf of subscriber. Method of process application consists of three interdependent modules which include: 1. User application 2. Subscriber application and 3. Web-based application.

Further, financial management approach for subscriber such as calculating tax, providing assistance in submission of regulatory documents with specific to multiple countries or single country by being compliant with regulatory norms and filing of tax on time with automated service is approached by the secured procedural application of our invention.

There is a dearth of known online platforms which create online opportunities for artists. Applications of prior art have targeted at free updates regarding the favorite artists such as musician, singer, DJ, Photographers, actors, actresses and famous media personalities. Such online applications do not fetch any income for the artists. Also some platforms which provide projects to generate revenue for the artists do not assist in the financial management process in accordance with regulatory laws of that particular country. Financial management process such as filing tax on time by going through the cumbersome process is very tedious without automated service.

Furthermore, existing personal payment systems may cause users inconvenience due to lack of mechanisms that could minimize the efforts of the payer to initiate or complete a payment transaction. Also some systems provide limited mechanisms for payee to initiate transactions. And often the tax filing and tax form requirement details, calculations are very inconvenient and not personalized. Thus existing platforms are limited in service related to creating revenue opportunities in combination with financial management assistance of individuals on the same platform.

Prior art patent applications US20150058188A1, U.S. Pat. No. 7,991,649B2, US20150058188A1, U.S. Ser. No. 10/636,084, U.S. Ser. No. 10/679,284, U.S. Pat. No. 10,586,278, WO2014200439A1, US20140173648A, US20140316906A1, US20170124527 and US20160343037A1 mentioned do not cover complete or sequential aspects of the invention process mentioned below. Patent documents covered in the prior art cover incomplete or partial aspects of invention and person having technical knowledge approach as our invention is not obvious to initiate. Prior art applications mentioned above do not cover aspects of our invention as a complete process. Thus, aim of the present invention overcomes prior art cited above and is as follows.

Present invention relates to method of secured procedural application which involves in revenue generation by creating opportunities for the set of population which include but not limited to artists such as musician, singer, DJ, Photographers, actors, actresses and famous media personalities and followed by assisting them with automated service in financial management assistance, which comprises of but not limited to services such as income generation, income calculation, tax calculation out of income generated, submission of regulatory information for calculated tax, filing of calculated tax with automated approach makes it easy for subscriber. Otherwise, which is inflexible, inconvenient way to calculate tax, filing procedure in various countries to be in compliance with regulatory norms and tax submissions based on regulations of specific country.

The secured procedural application involves automated specialized calculating tool makes it easier for the calculation of tax, specialized software for filing tax of the subscriber with regulatory compliance towards specific country of choice.

In one of embodiments of following description, various aspects of exemplary embodiments of the subject matter defined in the appended claims are described. For purposes of explanation and understanding, specific configurations and details are set forth in order to provide a thorough understanding of this claimed subject matter, well-known or understood features may be omitted or simplified in order not to obscure this understanding.

It will also be understood that these exemplary embodiments are not intended to be limiting, and those possessing ordinary skill in the art and having access to the teachings herein will recognize additional implementations, modifications, and embodiments, as well as other applications, which are fully contemplated herein as within the scope of what is disclosed and claimed herein.

### SUMMARY OF THE DISCLOSURE

Present invention relates to method of secured procedural application which creates opportunities for generation of revenue followed by automated management of same on single platform. Automated revenue management comprises but not limited to revenue generation, displaying generated revenues received, with holding a percent of revenue as service fee and providing automated tax filing service on behalf of subscriber. Method of process application consists of three interdependent modules which include: 1. User application 2. Subscriber application, 3. Web-based application.

Further, financial management assistance approach for subscriber such as calculating tax, providing assistance in submission of regulatory documents with specific to multiple countries or single country by being compliant with regulatory norms and filing of tax on time with automated service is approached by the secured procedural application of our invention.

In one of the embodiments, present invention relates to understanding of tax system globally, and performing tax filing related assistance to personalized requirements of subscriber based on tax system regulations of specific country or group of countries.

The secured procedural application involves automated specialized calculating tool to make it easier for the calculation of tax, specialized software for filing tax of subscriber with regulatory compliance towards specific country of choice or multiple countries.

Present invention relates to method of secured procedural application which involves in revenue generation by creating opportunities for the set of population (artists such as musician, singer, DJ, Photographers, actors, actresses and celebrities) and followed by providing financial management assistance to them with automated service.

In one of the embodiments of present invention relates to method of secured procedural application which creates opportunities for generation of revenue followed by automated management of same on single platform.

In one of the embodiments of present invention relates to method of secured procedural application which creates opportunities for generation of revenue followed by automated management of same on single platform, which comprises of but not limited to three interdependent modules.

In one of the embodiments of present invention relates to process and method of application, where in the application comprises of three interdependent modules are sequentially: User application, Subscriber application and Web-based application.

In one of the embodiments of the present invention, is related to method and process of application for revenue generation for subscriber using “User application module”, where in subscriber gets revenue out of performing interactive tasks such as engaging one or more users by interaction.

In one of the embodiments of the present invention, is related to method and process of application for revenue generation for subscriber using “User application module”, where the interactive tasks includes but not limited to texting, blogging, sending photos, playing live songs by one or more subscribers on request of one or more users and performing for events booked by one or more users.

In one of the embodiments of present invention “User Application module” targets Users belonging to set of population such as fans and admirers of work of one or more subscribers.

In one of the embodiments of present invention “User Application module” targets subscribers, belonging to set of population such as but not limited to artists, musician, singer, photographers, DJ celebrities and person serving entertainment industry.

In one of the embodiments of present invention” User Application module “creates revenue generating opportunities to subscribers.

In one of the embodiments of present invention “User application module” creates a customized interface for the User for payment transaction. Thus, User payment transaction provides an interface where in the payment will be transferred and activation of User account is generated.

In one of the embodiments of present invention” Subscriber application module” manages the opportunities created on the User module application. Further, the management includes display of events to be performed for a period of month, displaying receipt of payments from users, displaying the codes to be activated received from Users and display of payments from Users.

In one of the embodiments of present invention” Subscriber application module” includes but not limited to interacting with Users by sending messages, posts, photographs and any specific work of subscriber.

In one of the embodiments of present invention “Web-based application module “includes but not limited to automated management of revenue earned by subscriber using User and Subscriber application modules.

In one the embodiments of present invention “Web-based application module “includes automated management of revenue, which comprises of following criteria such as, but not limited to:
1. Display of income transferred from user account as payment received
2. Display of calculations of payment generated
3. Display of withholding a percent of income generated towards the service fee for application
4. Calculating tax from income, by entering the details in automated software already installed in application
5. Display of calculated tax amount to be paid after withholding service fee towards tax
6. Submission of formal details of subscriber into specialized software called TURBOTAX for filing
7. Display of tax submission status with respect to processing such as but not limited to:
   a. Calculating tax amount to be paid
   b. Entry of formal details required for tax filing in a specific country
   c. Processing of tax filing
   d. Tax filing successful

Further, to above embodiments, process of method and application with three interdependent module cover:
A. User application module which is managed by User:
   1. Involves registration of the User and Subscribers on payment.
   2. Logging in of user and subscriber using login credentials
   3. Submission of specific code for interacting with subscriber
   4. Interaction of subscriber and User
   5. Requesting a subscriber for permission to perform for event
B. Subscriber Application module managed by subscriber
   1. Approval of user's request to perform on event by subscriber
   2. Facilitating services such as displaying organized event calendar
   3. Displaying of payment updates
   4. Approval of code submitted by user for activation of interaction with subscriber
   5. Displaying revenue generated in User application module as income
C. Web-based application module administered by subscriber displays following options for successful payment of tax:
   1. Display of Revenue generated in User application module
   2. Display of Accounting option
   3. Display of real time additions, subtractions, personal set with holdings
   4. Display of automated calculation software
   5. Display of specialized Tax submission software “TURBOTAX”
   6. Manual setting for entry of earning to “TURBO TAX”
   7. Display of other pertinent levels such as current tax bracket levels
   8. Creation of Tax filing forms
   9. Payment of tax on behalf of subscriber
   10. With holding a percentage of earning towards service fee on behalf of the application Brief Description of the Drawings
   11. Display of calculations of income generated

### DETAILED DESCRIPTION

The subject matter of embodiments disclosed herein is described to meet specificity statutory requirements, but this description is not necessarily intended to limit the scope of the claims.

Embodiments will be described more fully here in after with reference to accompanying drawing which form part thereof and which show, by way of illustration, exemplary embodiments by which the systems and methods described herein may be practiced.

Among other things, the present subject matter may be embodied in whole or in part as a system, as one or more methods, or as one or more devices. Embodiments may take the form of a hardware implemented embodiment, a software implemented embodiment, or an embodiment combining software and hardware aspects.

Present invention relates to method of secured procedural application involves in revenue generation by creating opportunities for the set of population (artists such as musician, singer, DJ, Photographers, actors, actresses and famous media personalities) and followed by assisting them with automated service, by otherwise inflexible, inconvenient way of tax calculation, tax filing procedure and tax submissions based on regulations of specific country.

In continuation with above embodiment, term musician, singer, means a person who plays a musical instrument, especially as a profession, or is musically talented. Term musician, singer, may include following but not limited to guitarist, flutist, pianist, drummer, synthesizer, composer, anyone who conducts or performs music, instrumentalist, multi-instrumentalist etc. Term musician also includes a person having possible skills such as but not limited to performing, conducting, singing, rapping, composing, arranging and orchestration of music. And further DJ is a person a person who introduces and plays recorded popular music on radio.

In one of the embodiments of invention, term photographer is a person who makes photographs, and includes but not limited to Amateur photographer, professional, photographer, cinematographers, videographers, camera operators etc. Further, an actor or actresses is a person who portrays a character in a performance. The actor performs “in the flesh” in the traditional medium of the theatre or in modern media such as film, radio, and television. Actor or actress herein, refers to actor or actresses from all film industries around the world.

Famous media personality's is person or people and are famous on social media platform for showcasing their talent by means of videos, posts, blogs etc.

In one of the embodiments of present invention relates to one or subscribers from Entertainment industry is defined as follows, Entertainment is a form of activity that holds the attention and interest of an audience or gives pleasure and delight. It can be an idea or a task but is more likely to be one of the activities or events that have developed over thousands of years specifically for the purpose of keeping an audience's attention. Although people's attention is held by different things, because individuals have different preferences in entertainment, most forms are recognizable and familiar. Storytelling, music, drama, dance, and different kinds of performance exist in all cultures, were supported in royal courts, developed into sophisticated forms and overtime became available to all citizens. The process has been accelerated in modern times by an entertainment industry that records and sells entertainment products. Entertainment evolves and can be adapted to suit any scale, ranging from an individual who chooses a private entertainment from a now enormous array of pre-recorded products; to a banquet adapted for two; to any size or type of party, with appropriate music and dance; to performances intended for thousands; and even for a global audience.

In one of the embodiments related to tax which is defined as a compulsory financial charge or some other type of levy imposed upon a taxpayer (an individual or legal entity) by a governmental organization in order to fund government spending and various public expenditures.

In one of the embodiments, present invention relates to understanding of tax system globally, and performing tax filing related assistance to personalized requirements of subscriber based on tax system regulations of specific country or group of countries. Further, tax system is explained as follows: Most countries have a tax system in place to pay for public, common or agreed national needs and government functions. Some levy a flat percentage rate of taxation on personal annual income, but most scale taxes based on annual income amounts. Most countries charge a tax on an individual's income as well as on corporate income. Countries or subunits often also impose wealth taxes, inheritance taxes, estate taxes, gift taxes, property taxes, sales taxes, payroll taxes or tariffs.

In one of the embodiments of present invention relates to financial assistance management such as tax filing but not limited to wealth taxes, inheritance taxes, estate taxes, gift taxes, property taxes, sales taxes, payroll taxes or tariffs.

In one of the embodiments of present invention relates to revenue or income generation by creating opportunity and term income or income generated is defined as consumption and saving opportunity gained by an entity within a specified timeframe, which is generally expressed in monetary terms.

Further, to above embodiment, present invention has a specialized soft ware which comprises of tax regulations of all the possible countries but not limited United States, Europe, Canada, Germany, India . . . .

In one of the embodiments the procedural application is automated process having tax related form templates, with respect to specific country. Such tax related forms have been listed but not limited to are Form-16, Form-16A/Form-16B/Form-16C., Form-16A/Form-16B/Form-16C and Form 26AS etc.,

From above embodiments specific set of populations means but not limited to individuals, who professes and practice imaginative art and person skilled in one of the fine arts. Set of population mentioned above belong to category of artists, which includes but not limited to musician, singer, composers, editors, photographers, famous media personalities, dancers, pop singers, DJ and famous media personalities etc. List of examples mentioned belongs to entertainment industry. Henceforth, set of population mentioned so will be called as subscriber/subscribers.

Secured procedural application primarily aims at serving or providing assistance to subscribers with 3 modules and charging a nominal fee for the service.

Furthermore, fans include set of population or person who is fan or admirer of work of an artist and would feel accomplished to interact with artist or subscriber. Fan will be mentioned henceforth as User/Users.

In one of the embodiments of present invention relates to using the secured procedural application as a whole method including all three modules or partly a single module and or a combination of two modules.

In one of the embodiments of present invention relates to method of secured procedural application which creates opportunities for generation of revenue followed by automated process of same on single platform.

In one of the embodiments of present invention relates to method of secured procedural application which creates opportunities for generation of revenue followed by automated management of same on single platform, which comprises of but not limited to three interdependent modules.

Secured procedural application consists of 3 modules which are interdependent involved in creating single platform for individual starting earn from interaction created for him/her and completing final step of process where automated application helps individual to file taxation process.

In one of the embodiments of present invention relates to process and method of application, where in the application comprises of three interdependent modules are sequentially: User application, Subscriber application and Web-based application.

User Application:

In one of the embodiments of the present invention, is related to method and process of application for revenue generation for subscriber using “User application module”, where in subscriber gets revenue out of performing interactive tasks such as engaging one or more users by interaction. Further, interaction here is by means of word interaction such as messages, bog posts, video calling, voice calling, live chat etc.

In one of the embodiments of present invention, detailed explanation of the User application is as follows:

User Application is first module amongst above three modules mentioned in secured procedural application. It is interface created for mobile usage and web usage. This application mainly provides income source or revenue generation for subscriber.

User application also provides opportunity for the Users to interact with favorite subscriber. User provides all information required for registration and creation of user account. It is a secured application which needs a combination or individual log in credentials for access. Registration is payment based and upon successful registration application provides verification code.

User has to submit code mentioned by application for activation or accessing of individual account. After access user application creates customized or personalized interface for User. Personalized display of interface has various options through which user can interact with subscriber.

After above step, User has to send a request to subscriber for initiating to communicate with subscriber. After receiving the conversation access, user can interact with subscriber.

In one of the embodiments of the present invention, is related to method and process of application for revenue generation for subscriber using “User application module”, where the interactive tasks includes but not limited to texting, blogging, sending photos, playing live songs by one or more subscribers on request of one or more users and performing for events booked by one or more users.

In one of the embodiments of the present invention, is related to method and process of application for revenue generation for subscriber using “User application module”, where the interactive tasks includes but not limited to texting, blogging, sending photos, playing live songs by one or more subscribers on request of one or more users and performing for events booked by one or more users.

Furthermore, process of interaction or communication represents following but not limited to sending messages to subscriber, requesting to activate account, requesting subscriber for individual photographs, virtual meeting, autographs, request to share any thought on interested area of conversation, request for song if one of the subscriber is DJ and so mentioned subscriber is active online. Requesting subscriber to perform for event requested by individual.

In one of the embodiments of present invention” User Application module “creates revenue generating opportunities to subscribers. Payments received from user are redirected to subscriber account and displayed as payment receivables on module second interface or subscriber application. Further, creating “revenue generating opportunities” means but not limited to when user wants to communicate or interact with subscriber, a fixed amount is payable through procedural application which is redirected to subscriber account by withholding a percent as service fee. And sending request to subscriber, to perform for an event, after fixed amount payable set by application for specific subscriber or subscribers.

### Subscriber Application:

In one of the embodiments of present invention” Subscriber application module” manages the opportunities created on the User module application. Further, the management includes display of events to be performed for a period of month, displaying receipt of payments from users, displaying the codes to be activated received from Users and display of payments from Users. Display of events to be performed over a month mentioned above is recorded by automatically by subscriber application whenever there is booking request performed by user upon payment fixed by application.

In one of the embodiments of present invention “User Application module” targets subscribers, belonging to set of population such as but not limited to artists, musician, singer, photographers, DJ and person serving entertainment industry.

In one of the embodiments of present invention “Subscriber application module” includes but is not limited to interacting or communicating with Users by sending messages, posts, photographs and any specific work of subscriber.

“Subscriber application module” or module 2 is mobile based application, which is created for usage of subscribers only. Subscriber registers by entering individual details. After registration process, further log in credentials are required for activation. After entering log in credentials verification code is sent to subscriber. And verification code entry to required login initiates activation.

Upon activation subscriber interface leads to new personalized virtual display of options but not limited to and which are provided by the application are as follows:
1. Subscriber manages application
2. Payment methods, which contains details of payment received from users.
3. Option for posting messages, writing posts, posting pictures, posting opinion on any topic of interest
4. Confirming the request from User for activation of communication or interaction with subscriber
5. Acknowledging confirmation of performing at event requested by user.

### Web-Based Application

In one of the embodiments of present invention “Web-based application module “includes but not limited to automated management of revenue earned by subscriber with usage of User and Subscriber application modules.

The secured procedural application involves automated specialized calculating tool to make it easier for the calculation of tax, specialized software for filing tax of subscriber with regulatory compliance towards specific country of choice.

In one of the embodiments of present invention related to specialized software for submission of tax filings include but not limited to TURBOTAX.

These requirements may relate to providing accurate information regarding certain financial methods of operations for an individual, company or a business. Where in individuals are often burdened by accounting, taxation, securities, and/or other financial disclosure requirements.

One specific requirement of financial disclosure involves the appropriate opportunity of revenue inflow and assisting in accounting, taxation by following secured procedural filing of regulatory laws and jurisdiction of individual country.

In one of the embodiments of present invention “Web-based application module “includes automated management of revenue, which comprises of following criteria such as, but not limited to:
1. Display of income transferred from user account as payment received
2. Display of calculations of payment generated
3. Display of withholding a percent of income generated towards the service fee for application
4. Calculating tax from income, by entering the details in automated software already installed in application
5. Display of calculated tax amount to be paid after withholding service fee towards tax
6. Submission of formal regulatory details of subscriber into specialized software called TURBOTAX for filing
7. Display of tax submission status with respect to processing such as but not limited to:
   a. Calculating tax amount to be paid
   b. Entry of formal details required for tax filing in a specific country
   c. Processing of tax filing
   d. Tax filing successful

Further, to above embodiments, process of method and application with three interdependent module cover:
i) User application module which is managed by User:
   1. Involves registration of the User and Subscribers on payment.
   2. Logging in of user and subscriber using login credentials
   3. Submission of specific code for interacting with subscriber
   4. Interaction of subscriber and User
   5. Requesting a subscriber for permission to perform for event
ii) Subscriber Application module managed by subscriber:
   6. Approval of user's request to perform on event by subscriber
   7. Facilitating services such as displaying organized event calendar
   8. Displaying of payment updates
   9. Approval of code submitted by user for activation of interaction with subscriber
   10. Displaying revenue generated in User application module as income
iii) Web-based Application
   11. Web-based application module administered by subscriber
   12. Display of Revenue generated in User application module
   13. Display of Accounting option
   14. Display of real time additions, subtractions, personal set with holdings
   15. Display of automated calculation software
   16. Display of specialized Tax submission software “TURBOTAX”
   17. Manual setting for entry of earning to “TURBO TAX”
   18. Display of other pertinent levels such as current tax bracket levels
   19. Creation of Tax filing forms
   20. Payment of tax on behalf of subscriber
   21. With holding a percentage of earning towards service fee on behalf of the application Brief Description of the Drawings
   22. Display of calculations of income generated

Figures below are illustrating elements or components of an example overview of the method of secured procedural application involving three interdependent modules each have one or more processors in which an embodiment of the subject matter disclosed herein may be implemented. Where, “User application 101”, describes about the process of registration into User Application by both Users and Subscribers.

Following steps describe the process of registration

Step 1: Registration of User- User registers into the application by entering details such as Name, age, country of residence, Unique ID number and other important details required by application, if any.
Step 2: Registration of Subscriber-Subscriber registers into the application by entering details such as Name, age, country of residence, Unique ID number and other important details required by application, if any.
Step 3: Code provided by application-After completion of above steps, application provides first time code for both users and subscribers.
Step 4: Log in using code-User and Subscriber enter the Code provided by the application and login to application.
Step 5: The activation of user interaction with subscriber follows.

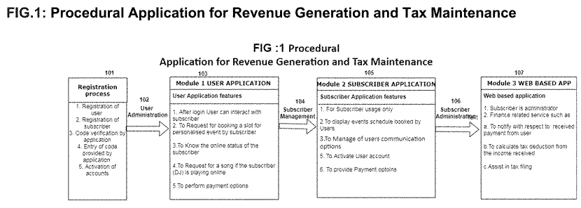

FIG. 1: Secured procedural Application for Revenue Generation and Tax Maintenance

From FIG. 1 for further illustration-(102) describes the continuity from the registration process to activation of User application, where User is the administrator of the module (103). (103) further describes following features of the User application such as:
1. User page where in, User can receive the posts, message and photographs sent by the subscriber and can find the status of the subscriber.
2. User page further displays following features such as:
   i. Payment settings
   ii. Request for booking favorite subscriber
   iii. Online status of subscriber
3. Another feature includes, where user can request a song through the User application, when possibly subscriber is artist or DJ and is live.
4. User page displays payment option

In continuation with above features of (103) Module 1 is subscriber management (104) of secured procedural application which leads to second module (105). Further, following features of Subscriber application (105) is virtual page which includes but not limited to following feature in brief:
1. Subscriber application is meant for subscriber usage only.
2. Subscriber application displays request from User application module 1 (103).
3. It also includes the option to manage user communication such as not limited to interacting with users by sending messages, posts, photographs and playing songs request by user when subscriber active online.
4. Subscriber application has option of activating user account in subscriber's group
5. Option related to payments received from the User for activation.
6. Option where subscriber can see user requests booking slots
7. Payment options such as receivables and deliverables.
8. Payment settings for application for providing service

From FIG. 1, for further illustration (106) includes Subscriber Administration and is part of secured procedural application including Module 3 Web-based application (107) which covers important feature of Web-based application as follows:
1. For Web-based application, subscriber is the administrator
2. To display finance related services for subscriber
3. To notify received payment from User account
4. To calculate the tax deduction from income received
5. To provide assistance for subscriber with respect to tax filing

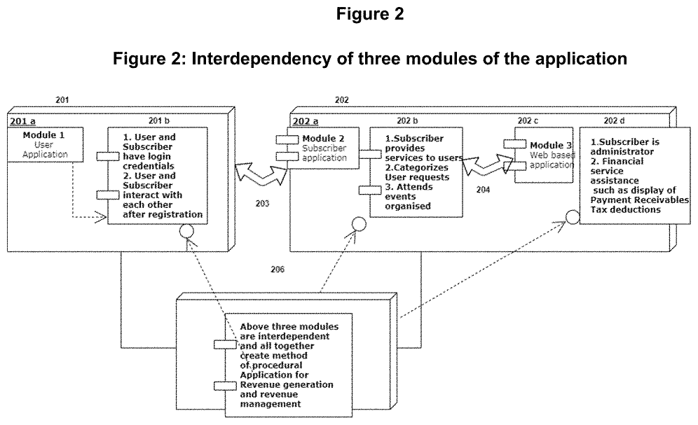

FIG. 2: Interdependency of three modules of the application FIG. 2; relates to Interdependency of three modules of the application which include 201, 202 and 206 respectively. It signifies the importance of interdependency and continuation of the application. Three modules 201,202 and 203 are dependent on each other for the subscriber to initiate revenue generation and finance management of revenue generated.

Thus, 201 further includes Module 1 User application 201a, which mainly has features 201b, which are User and Subscriber have login credentials and User and Subscriber interact with each other after registration.

Further, 203 describes the interlink between 201 which includes User application and 202, which includes Module 2 Subscriber Application 202a and 202c Web-based application. Main features of Subscriber application 202a i.e following features 202b which include where:
1. Subscriber provides services to users
2. Categorizes user requests based on first raised request for booking.
3. Subscriber attends the events so organized

Further to illustration on FIG. 2, 206 emphasizes on the continuation from User application to Web-based application for method of secured procedural application where in, Subscriber gets a platform where he/she can generate revenue by opportunities available at module 1 User application 201, and managing the opportunities at module 2 Subscriber application 202a. And at module 3 Web-based application for financial management assistance which more specifically includes calculation, submitting tax related drafts through a automated software tool for filing of Tax.

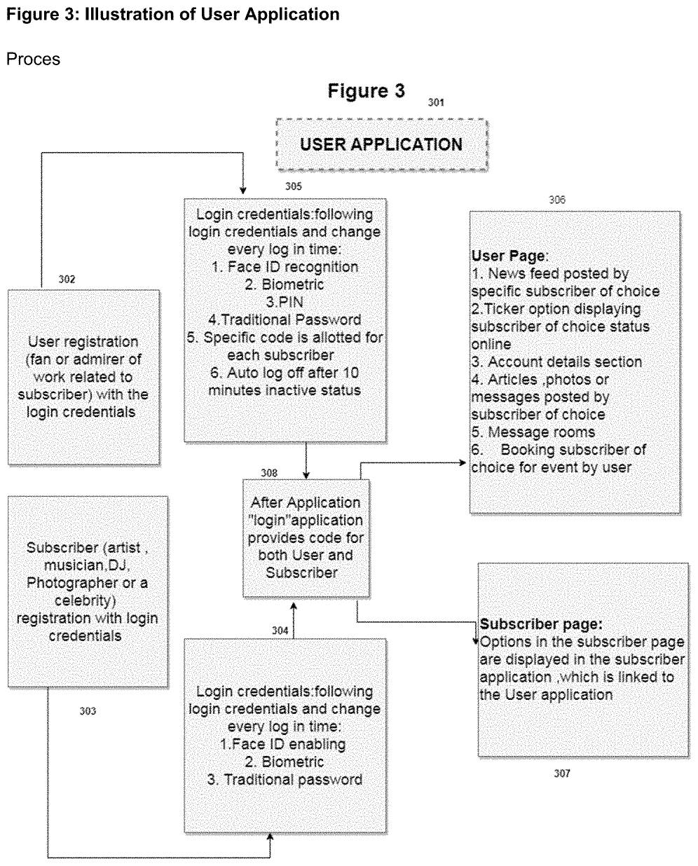

FIG. 3: Illustration of User Application

FIG. 3: Provides detailed description and features of User Application: Further to illustration of FIG. 3, includes User Application 301. User application is a programmed on the iOS and Android platforms it will be updated for every new update for iOS. User application is a log in only application. The procedure of registering with User application 301 has a series of steps involved. Following are the secured procedural steps for registration and activating the user and Subscriber include but not limited to include:

Step 1: Includes 302 where User (User belongs to set of population which includes fan or admirer of work related to one or more subscriber) registers for the access into the application. And ways to access the application are but not limited to by enabling the face ID, biometric, by allotment of PIN number, by assigning a traditional password with username and first time user registration.

Step 2: In continuation with to above step First user registration involves email verification with code, phone number verification with code, along with first and last name.

Step 3: After submission of above details, name of User which has to be entered In User page as display name has to be submitted.

Step 4: In continuation with step 3, User submits all the mentioned credentials and upon submission of Application has to provide, invite code which is specific code from the subscriber for activation of invitation to subscribers group.

Step 5: Subscriber (subscriber belongs to set of population such as but not limited to Artists, Actors, Actress, musician, singer, DJ and famous media personalities) registration process is similar to above step 2 and 3 i.e., User registration process.

Step 6: After successful registration process of User and Subscriber, activation of the accounts is created. User and Subscriber pages are created.

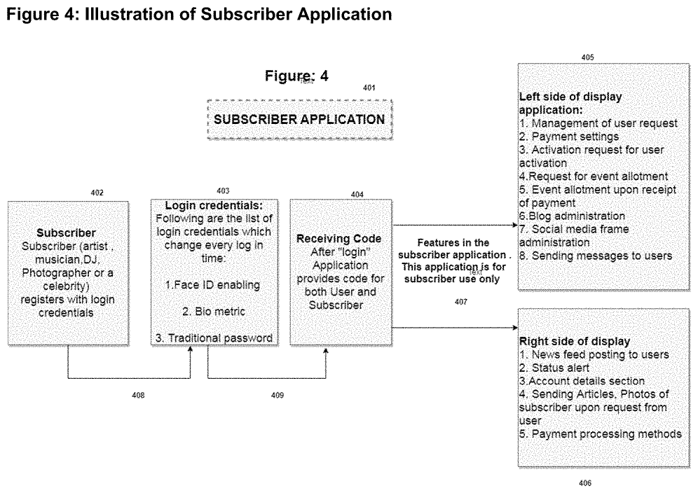

Step 7: User page especially has following Visual display options after registration which include but not limited to:
a. News feed posted by specific subscriber of choice
b. Ticker option displaying subscriber of choice status online
c. Account details section which includes payment methods, personal information section
d. Articles, photos or messages posted by subscriber of choice
e. Message rooms
f. Booking subscriber of choice for event by user.
g. Picture editing section
h. Method of payment options such as credit card entry
i. Song request option such as stored request which goes to the DJ along with other details like date and time stamped with name of the person who requested the song.
j. User also has log out feature if inactive for more than 10 minutes
With respect to further illustration of Subscriber page 307 features of the subscriber application are displayed in FIG. 4: Subscriber application.

FIG. 4 Subscriber Applications:

FIG. 4 Illustrative process of the subscriber application 401 is explained in detail in the following steps:

Step 1: Subscriber registers with login credentials

Step 2: Login credentials of step 1 include but not limited to recognition of Face ID, Biometric, and Traditional password.

Step 3: After registering with any of the log in credentials, application send a code for verification and activation of registration

Step 4: After successful activation, further to above process virtual display of subscriber page is displayed.

Step 5: Step 5 displays the options available on the left side of virtual display, which include but not limited to

a. management of user request for activation

b. Payment settings

c. Activation requests for user activation

d. Request for event allotment

e. Event allotment upon receipt of payment

f. Blog administration

g. Social media frame administration

h. Sending message to users

Step 6: In continuation to step 5, step 6 displays options on the right side which are but not limited to:

a. NEWS feed posting of Users section

b. Status alert of subscriber

c. Account details section

d. Sending articles option

e. Posting of photos option

f. Payment processing methods

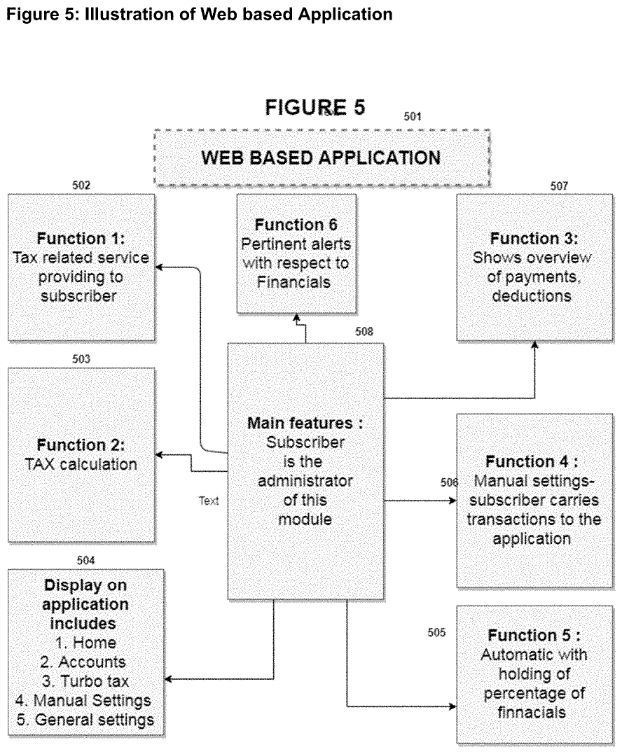

FIG. 5: Web-Based Application

For Illustrative purposes features of Web-based application, 501 are explained in detail:

a. Function 1: Tax related service providing to subscriber

b. Function 2: Tax calculation

c. Function 3: Shows overview of payments deductions

d. Function 4: Manual settings-subscriber carries transactions to the application

e. Function 5: Automatic with holding of percentage of financials

f. Function 6: Pertinent alerts with respect to financials

In continuation with functions mentioned above the virtual display features of Web-based application, but not limited to are mentioned below:
a. Home
b. Accounts
c. Turbotax
d. Manual settings
e. General settings

We claim:

1. A method of secured procedural application that creates opportunities in generating revenue, followed by continuation in providing automated financial management assistance of revenue so formed on a single platform.

2. A method of secured procedural application comprising of respectively;
a. User Application
b. Subscriber Application
c. Web-based Application respectively.

3. A method of procedural application comprising of:
a. User application which involves in generating revenue with the registration of users to interact with one or more subscribers;
b. Subscriber application which involves in acceptance of an invitation from subscriber to interact with the user and receives income as registration fee;
c. A Web-based application that involves in financial management assistance of income received as registration fee.

4. A method of claim 1, where in, user application includes a process of registration of subscriber, including from a set of the population of the entertainment industry such as artist, actor, actress, musician, singer, DJ, Photographer, famous media personalities.

5. A method claim 1, wherein, a web-based application comprises of financial management assistance approach for subscriber such as calculating tax, providing assistance in submission of regulatory documents with specific to multiple countries or single country by being compliant with regulatory norms and filing of tax on time with automated service is approached by the secured procedural application of our invention.

6. A method of claim 1, wherein a web-based application involves an understanding of the tax system globally and performing tax filing related assistance to personalized requirements of subscribers based on tax system regulations of specific a country or group of countries.

7. A method of a process comprising of;
a. secured procedural application involving in revenue generation;
b. followed by an automated specialized calculating tool to make it easier for the calculation of tax;
c. specialized software for filing tax of subscriber with regulatory compliance towards the specific country of choice or multiple countries.

8. A method of use comprising of;
a. a secured procedural application involving in revenue generation;
b. followed by an automated specialized calculating tool to make it easier for the calculation of tax;
c. specialized software for filing tax of subscriber with regulatory compliance towards the specific country of choice or multiple countries.

9. A method of process and application with three interdependent modules comprising:
i. User application module which is managed by User;
a. Involves registration of the User and Subscribers on payment.
b. Logging in of user and subscriber using login credentials
c. Submission of specific code for interacting with subscriber
d. Interaction of subscriber and User
e. Requesting a subscriber for permission to perform for event
f. Subscriber Application module managed by subscriber
ii. Approval of user's request to perform on event by subscriber
a. Facilitating services such as displaying organized event calendar
b. Displaying of payment updates
c. Approval of code submitted by user for activation of interaction with subscriber
d. Displaying revenue generated in User application module as income
e. Web-based application module administered by subscriber displays following options for successful payment of tax:
iii. Display of Revenue generated in User application module
e. Display of Accounting option
f. Display of real time additions, subtractions, personal set with holdings
g. Display of automated calculation software
h. Display of specialized Tax submission software “TURBOTAX”
i. Manual setting for entry of earning to “TURBO TAX”
j. Display of other pertinent levels such as current tax bracket levels
k. Creation of Tax filing forms
l. Payment of tax on behalf of subscriber
m. With holding a percentage of earning towards service fee on behalf of the application Brief Description of the Drawings
n. Display of calculations of income generated
